(19) United States
(12) Patent Application Publication
(10) Pub. No.: US 2006/0252494 A1
(43) Pub. Date: Nov. 9, 2006

(54) Slot machine bonus game

(76) Inventors: Ignacio Gerson, Lantana, FL (US); Diego Yanivello, Latana, FL (US)

Correspondence Address: MUSKIN & CUSICK LLC, 1800 CALLOWHILL ST, SUITE 200, PHILADELPHIA, PA, 19130, US

(21) Appl. No.: 11/326,125

(22) Filed: Jan. 3, 2006

Related U.S. Application Data
(63) Continuation-in-part of application No. 11/035,691, filed on Jan. 14, 2005.
(60) Provisional application No. 60/597,956, filed on Dec. 27, 2005.

(51) Int. Cl. A63F 13/00

(52) U.S. Cl. 463/20

(57) ABSTRACT

A bonus round for a slot game. A player can continuously touch an active area on a touch screen in order to pet a virtual animal. A player can earn an award for the bonus round based on how well the player pets the virtual animal.

### CROSS REFERENCE TO RELATED APPLICATIONS

This application claims benefit and priority to provisional application No. 60/597,956, entitled, “Slot Machine Bonus Game,” filed on Dec. 27, 2005, which is incorporated by reference herein in its entirety. This application is also a continuation in part of application Ser. No. 11/035,691, entitled, “Slot Machine Game That Allows Player to Purchase Reel Respins,” which is incorporated by reference herein in its entirety.

### BACKGROUND OF THE INVENTION

1. Field of the Invention

The present invention is directed to an interactive bonus round for a slot machine game which can allow a player to earn additional awards in an enjoyable interactive fashion.

2. Description of the Related Art

Bonus rounds are typically triggered infrequently during slot play and provide a special treat for the player. A bonus game can provide the slot game with “personality” which make the game more enjoyable and also provide the player with an opportunity to win an additional award.

Most current bonus rounds are passive in nature, as the player just watches the screen or may make some random choices with no real control over the outcome or award.

What is needed is an enjoyable bonus round that players can interact with and players will enjoy such that they will continuously play and return to play the slot game.

### SUMMARY OF THE INVENTION

It is an aspect of the present invention to provide a wagering game which can be exciting to players.

The above aspects can be obtained by a method that includes (a) displaying an active area; (b) receiving continuous touching from a player inside the active area; and (c) awarding an award to the player after the continuous touching is completed.

The above aspects can also be obtained by a method that includes (a) dividing an active area into cells and initializing values of the cells; (b) allowing a player to touch any of the cells; (c) when the player touches a particular cell, adding a value of the particular cell to a point total and resetting the value of the particular cell; (d) increasing values of the cells; (e) continuing the allowing, adding, resetting and increasing, until a time limit is over; and (f) when the time limit is over, determining an award based on the point total.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a bonus round, according to an embodiment;

FIG. 2 is a screenshot illustrating an exemplary bonus round trigger, according to an embodiment;

FIG. 3 is screenshot illustrating a first exemplary active area using a dog, according to an embodiment;

FIG. 4 is a screenshot illustrating a second exemplary active area using a-cat, according to an embodiment;

FIG. 5 is a flowchart illustrating an exemplary method of computing an award amount, according to an embodiment;

FIG. 6A is a diagram illustrating an exemplary first state of cells, according to an embodiment;

FIG. 6B is a diagram illustrating an exemplary second state of cells, according to an embodiment;

FIG. 6C is a diagram illustrating an exemplary third state of cells, according to an embodiment;

FIG. 7 is a flowchart illustrating an exemplary method of displaying game states, according to an embodiment;

FIG. 8 is a screenshot illustrating an active area when the animal displays a content state, according to an embodiment;

FIG. 9 is a block diagram illustrating a network of gaming devices, according to an embodiment;

FIG. 10A is a flowchart illustrating an exemplary method of maintaining an distributing names of players who have successfully completed a bonus round, according to an embodiment;

FIG. 10B is an exemplary output of names of players who have successfully completed a bonus round, according to an embodiment;

FIG. 11 is a flowchart illustrating an exemplary method of triggering a bonus round, according to an embodiment;

FIG. 12 is a flowchart illustrating an exemplary method of implementing a guessing bonus round, according to an embodiment; and

FIG. 13 is flowchart illustrating an exemplary method of implementing a positive/negative guessing bonus round, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present general inventive concept relates to a method, system, and computer readable storage to implement a bonus round for a wagering game. The bonus round can implement continuous touching. Continuous touching can be a touching motion by the player wherein the player slides his or her finger across a touch screen. This is in contrast to touching discrete points on a touch-screen. While the present general inventive concept can be operated by touching discrete points without a sliding motion, the player may typically earn a greater award by sliding (touching continuously) his or her finger on the output device because the player can typically cover a greater surface area by sliding.

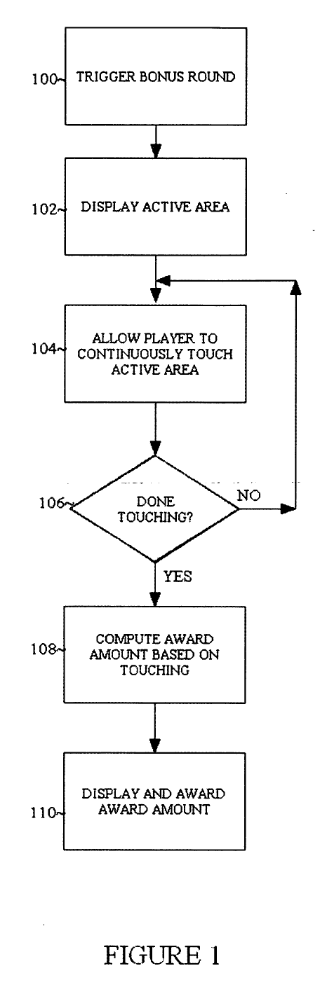

FIG. 1 is a flowchart illustrating an exemplary method of implementing a bonus round, according to an embodiment.

The method can begin with operation 100, wherein the bonus round is triggered. This can be done as known in the art, such as when a slot machine finishes spinning and displays a predetermined combination.

From operation 100, the method can proceed to operation 102, which displays an active area. An active area is an area on a screen that a player can touch in order to earn an award. An active area can for example be an animal such as a cat or a dog in which the player can “pet.” A player will try to pet the animal in such a way as to earn the largest award.

From operation 102, the method can proceed to operation 104, which allows the player to continuously touch the active area. A touch screen (or other input device) can be used to register where the player is touching on the active area. The continuous touching can be analyzed and used to determine an award at the end of the bonus round (to be discussed below in more detail).

From operation 104, the method can proceed to operation 106, which determines whether the player is done touching. This can be done, for example, by giving the player a predetermined time to perform the touching and once the time is up, the player is done touching. If the player is not done touching, then the method can return to operation 104, wherein the player can continue to touch the active area.

If the determination in operation 106 determines that the player is done touching, then the method can proceed to operation 108, wherein the method computes an award based on the player's touching. This will be discussed below in more detail.

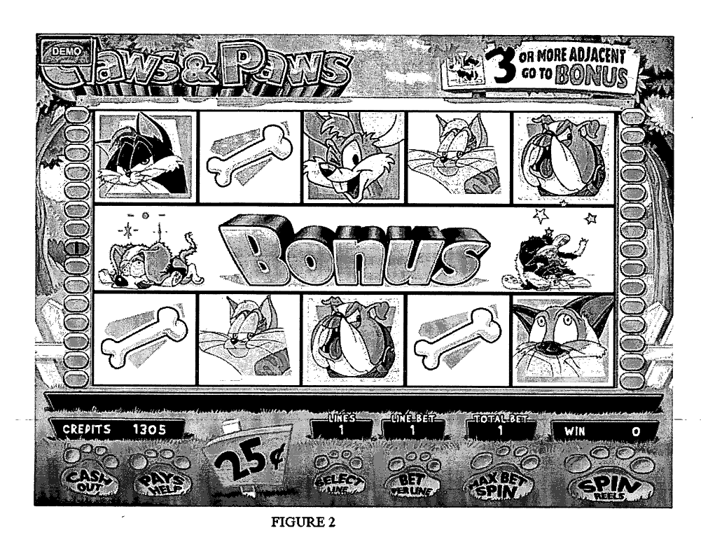

FIG. 2 is a screenshot illustrating an exemplary bonus round trigger, according to an embodiment.

When reels display a predetermined combination, an indication such as illustrated in FIG. 2 can indicate to the player that he or she has triggered a bonus round.

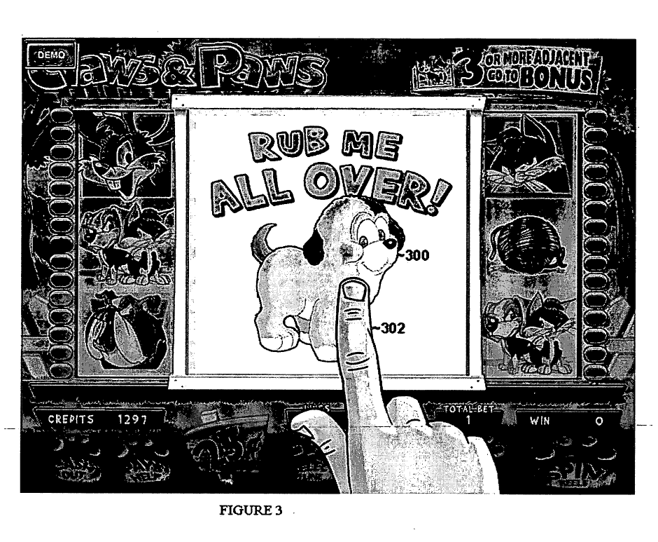

FIG. 3 is screenshot illustrating a first exemplary active area using a dog, according to an embodiment.

Active area 300 is a dog caricature that the player can touch. Outside of the active area 300 (e.g. outside of the dog) is not the active area and touching this area would typically have no effect. A player's finger 302 is typically used to touch the active area 300.

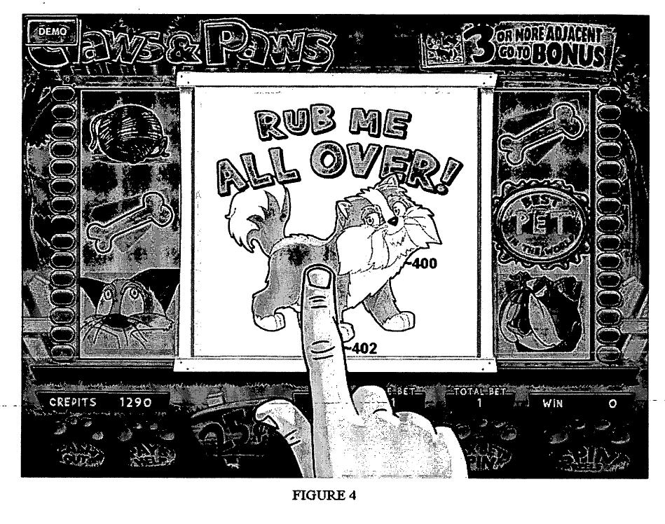

FIG. 4 is a screenshot illustrating a second exemplary active area using a cat, according to an embodiment.

Active area 400 is a dog caricature that the player can touch. Outside of the active area 400 (e.g. outside of the cat) is not the active area and touching this area would typically have no effect. A player's finger 402 is typically used to touch the active area 400.

When the player touches the active area, the player can be attempting to “pet” the animal to make the animal happier. The player may understand that the happier the animal as a result of the petting, the greater the award the player may earn from the bonus round. The player may or may not understand the algorithm used to determine the award. A number of such algorithms can be used.

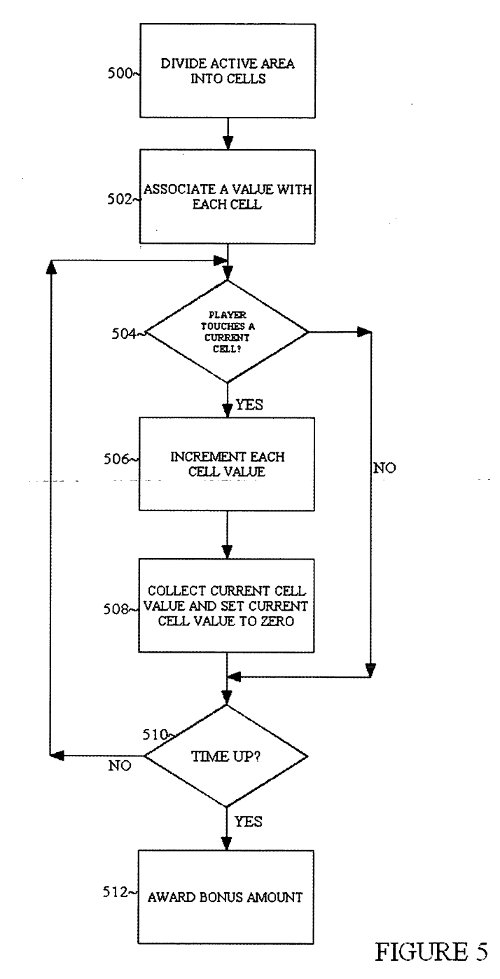

FIG. 5 is a flowchart illustrating an exemplary method of computing an award amount, according to an embodiment.

The method can begin with operation 500, which divides the active area into cells. Note that areas outside of and adjacent to the active area may be divided into cells to, but these cells typically are not active and do not have an effect on the award. Cell size can for example be measured in pixels and can, for example, be 20×20 pixels.

From operation 500, the method can proceed to operation 502, which associates a value with each cell. An initial value for each cell can for example be zero.

From operation 502, the method can proceed to operation 504, which determines whether a player touches (or is touching) a current cell (typically in the active area). A standard touch screen can be used which can return (x,y) coordinates of a touch. A table can be stored with (x,y) screen coordinates and their respective cell (each cell can be identified by a number or coordinate).

If the determination in 504 determines that the screen is being touched and an active cell (a cell in the active area) is being touched, then the method can proceed to operation 506, which increments each cell value. Each cell value can be incremented by a constant (such as one).

From operation 506, the method can proceed to operation 508, which collects the current cell value and sets the current cell value to zero. The value of the cell being touched (the current cell value) can be added to a cumulative point total, and then this cell value can then be reset to zero.

From operation 508, the method can proceed to operation 510, which determines whether an allotted time for the touching is over. A player can be given a predetermined amount of time, such as 8 seconds.

If there is time remaining, then the method can return to operation 504, and the method can continue. If there is not more time remaining, then the method can proceed to operation 512, which can award the bonus amount. The bonus amount can be equal to or determined from the cumulative point total.

Table I illustrates an exemplary mapping of final game states and uniform variables with their high and low limits. Reaching different game states is discussed below in more detail. The higher the game state, the better the “mood” of the pet.

As an example, if the player ends the bonus round in game state 2, then he or she can earn an award ranging from 4 to 6. The function U can return a random variable between the low range (in this case 4) and the high range (in this case 6) with a mean of (low+high)/2 or in this case 5. Thus, if the player has reached game state 4, then the least the player can earn is 8, the most the player can earn is 10, and the average award will be 9. The award can optionally be multiplied by the amount the player has bet (either in total or on an individual line) before being finally awarded to the player.

TABLE I

| state | range |
|---|---|
| 1 | U(2, 4) |
| 2 | U(4, 6) |
| 3 | U(6, 8) |
| 4 | U(8, 10) |

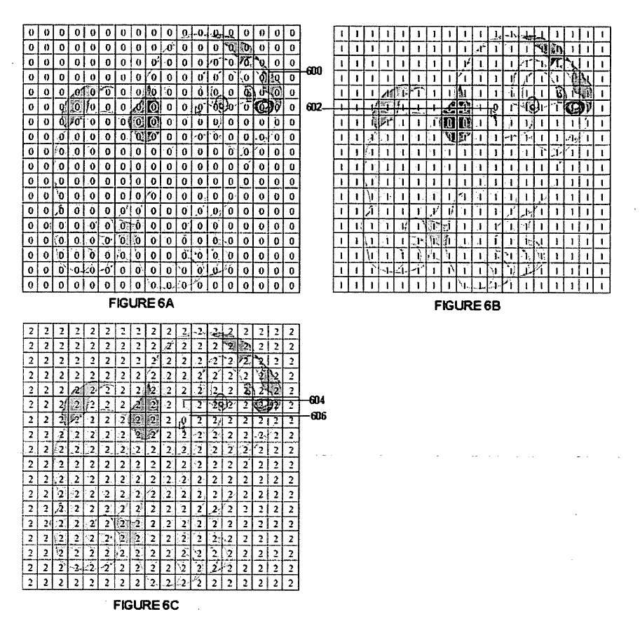

FIG. 6A is a diagram illustrating an exemplary first state of cells, according to an embodiment.

The active area 600 comprises the cells that are inside (or intersecting with) the animal caricature. This illustrates what can take place in operation 500 (which divides the active area into cells), and operation 502 (which associates a value with each cell—in this case zero).

FIG. 6B is a diagram illustrating an exemplary second state of cells, according to an embodiment.

In this state, each of the cells has been incremented by one, as can be accomplished by operation 506. The player has then touched a first touched cell 602, and this value is reset to zero (as in operation 508). The value of the cell before being reset to zero (one) is also accumulated (or collected) to a point total (as in operation 508).

FIG. 6C is a diagram illustrating an exemplary third state of cells, according to an embodiment.

The cells from FIG. 6B are all incremented, as can be accomplished by operation 506. Note that the first touched cell 602 from FIG. 6B corresponds to incremented first touched cell 604 in FIG. 6C. Incremented first touched cell 604 has a value of one since it is incremented by one from its previous state in FIG. 6B. Note that all cells never touched now have a value of two since the cells have undergone two incrementations since the initial state (FIG. 6A). Second touched cell 604 is then touched whose value (previously two) is then reset to a predetermined number (such as zero). This value (two) is also collected (accumulated) and the point total is now three (two points from touching the second touched cell and one point from touching the first touched cell).

As the player is successful in collecting points, the animal can indicate a more “content” state to the player, indicating the player is doing a good job of petting. For example, the animal can smile, purr, etc.

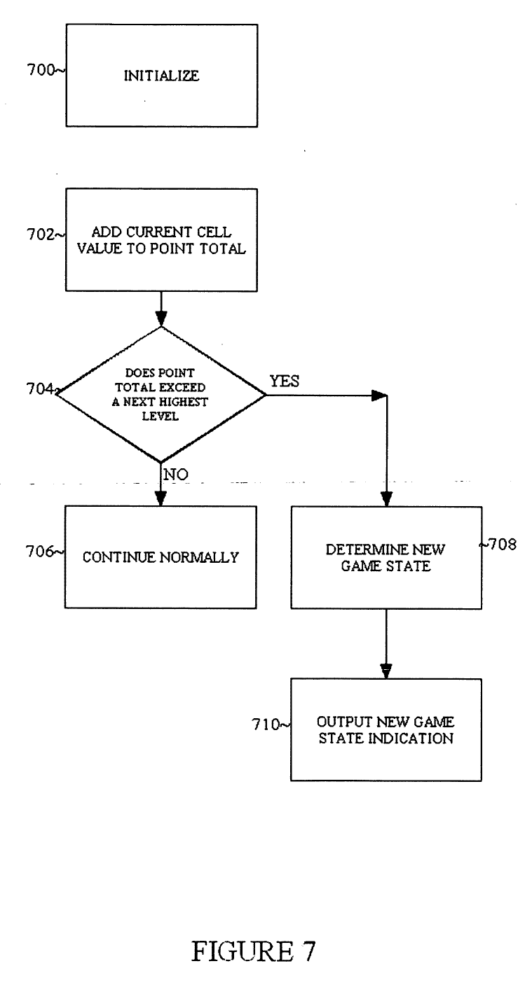

FIG. 7 is a flowchart illustrating an exemplary method of displaying game states, according to an embodiment.

The method can start with operation 700, which can initialize the method. This can, for example, set the different game states and requisite criteria to reach them (to be discussed below in more detail). Operations 702-710 can be implemented as part of operation 508 from FIG. 5.

Operation 702 can add the current cell value (the cell currently being touched) to a point total.

From operation 702, the method can proceed to operation 704, which determines if the point total exceeds a next highest level. Different point total can correspond to different levels. Table II illustrates one example of mapping point totals to levels.

TABLE II

| points | level |
|---|---|
| 0 | 1 |
| 1,000 | 2 |
| 5,000 | 3 |
| 10,000 | 4 |
| 50,000 | 5 |

Thus, for example, when the player starts the bonus round, the player typically will start with zero points, thus the player will start at level (or state) 1. When the player reaches 1,000 points, the player will have reached level (or state) 2. If the player accumulates (collects) 5,580 points, the player will be at level 3. The player will not be able to exceed level 5, no matter how many points the player can accumulate.

Thus, in operation 704, if the player's point total reaches the next highest level (from the player's current level), the player will have advanced to the next level. For example, if the player's current level is two, and then based on the player's latest collections, the player has accumulated 5,002 points, the player has now advanced to level (or state) 3.

From operation 704, if the player has not advanced to a next higher level (or state), then the method can proceed to operation 706 which can continue the game normally, as described herein (for example proceed to operation 510).

From operation 704, if the player has reached a higher level (or state), then the method can proceed to operation 708, which determines a new game state. This can be done by using a table, such as Table II. For example, the player may have advanced to game state 3.

From operation 708, the method can proceed to operation 710, which outputs a new game state indication. For example, when the player reaches a new game state, the animal can give a visual and/or auditory indication of its “contentment,” e.g. it can smile, purr, wag its tail, etc. From operation 708, the method can continue as described herein (for example proceed to operation 510).

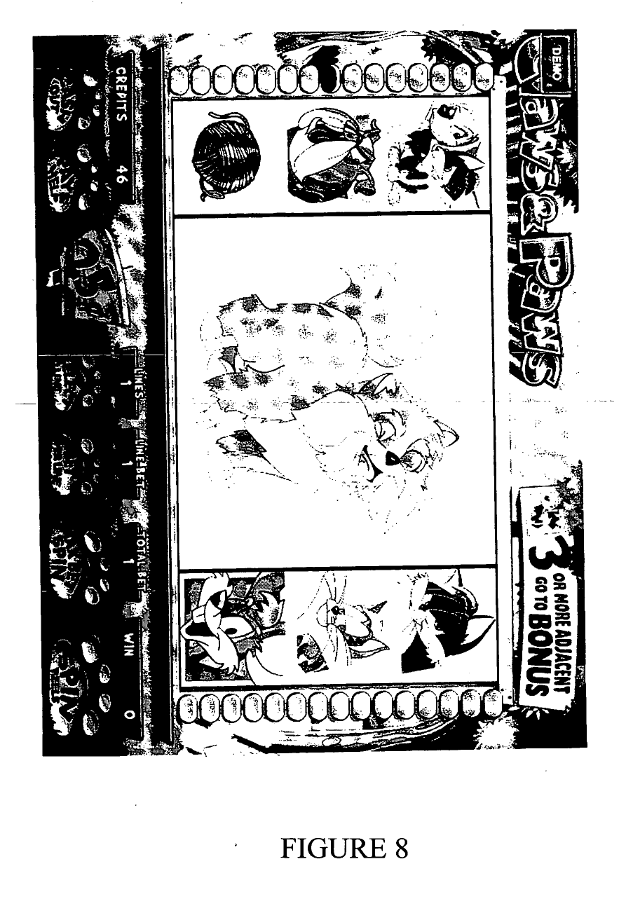

FIG. 8 is a screenshot illustrating an active area when the animal displays a content state, according to an embodiment.

The animal can display a smile, make a content sound (e.g. purr, etc), wag its tail, or any other indication the animal is “happy” and the player has achieved some success with his or her “petting” which would typically translate into a higher award amount.

An optimal way to play the bonus round would be to move touch cells as quickly as possible and touch all cells once before touching a same cell again. For example, the player can start at the top left of the pet and trace to the bottom, then move one cell to the right, then trace to the top, then move one cell to the right, then trace to the bottom, etc. When the rightmost cell is reached, this can be repeated.

In an implementation of embodiments described herein, computation time can be saved. In order to avoid the increment of cell's values each time the player moves the cursor, the cells can have a shared value that represents the current increment. With this schema, each time the cursor is moved, only the shared value is incremented (instead of increment each cell value, which can be more expensive). When a cell is requested for its value, it accesses to this shared value and returns it plus the cell value. When a cell needs to be collected, it set its value with the negative of the shared value (so the sum between the shared value and the cell value will be 0). Then, the improvement in cost is that whenever the cursor is moved, only the shared value needs to be updated.

In alternative embodiments, instead of incrementing cell values whenever the player touches a new cell, cell values can be incremented based on time (e.g. each second a cell will increase). Also, when initializing the cells, instead of setting each cell value to zero, cells may be given different initial starting values (either predetermined or random). The player may or may not know which areas (cells) of the pet would have the highest value.

In a further embodiment, the application Ser. No. 11/035,691, described a bonus round wherein a player can guess regarding undisclosed selected item(s). If the player guesses right, the player wins a top prize and the selected items are chosen anew. If the player does not guess right, the player may be given a hint and the selected item(s) to guess remain the same so that the next time the player triggers the bonus round the player can try again to guess the selected item(s).

The electronic gaming devices (EGDs) that implement the game can also be networked and connected to a central server/database. In an embodiment, a list of the players that have successfully completed the bonus round can be maintained and outputted on the electronic gaming devices.

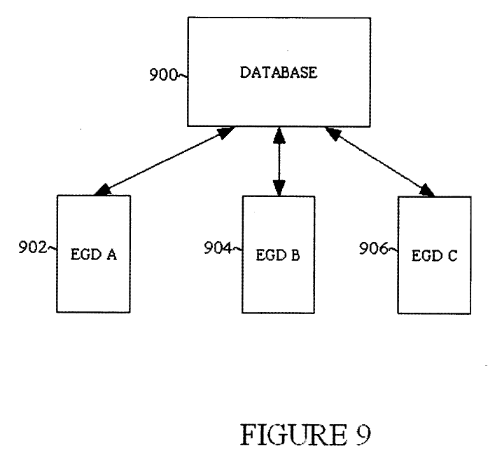

FIG. 9 is a block diagram illustrating a network of gaming devices, according to an embodiment.

A database 900 (and server) can be connected to electronic gaming device A 902, electronic gaming device B 904, and electronic gaming device C 906. When a player successfully completes the bonus round (guesses all selected item(s) correctly), the player can be prompted to enter his or her name. The name can then be transmitted to the database 900. The database 900 can then serve the list to any of the EGS 902, 904, 906 (or any others not pictured) so that the list can be outputted.

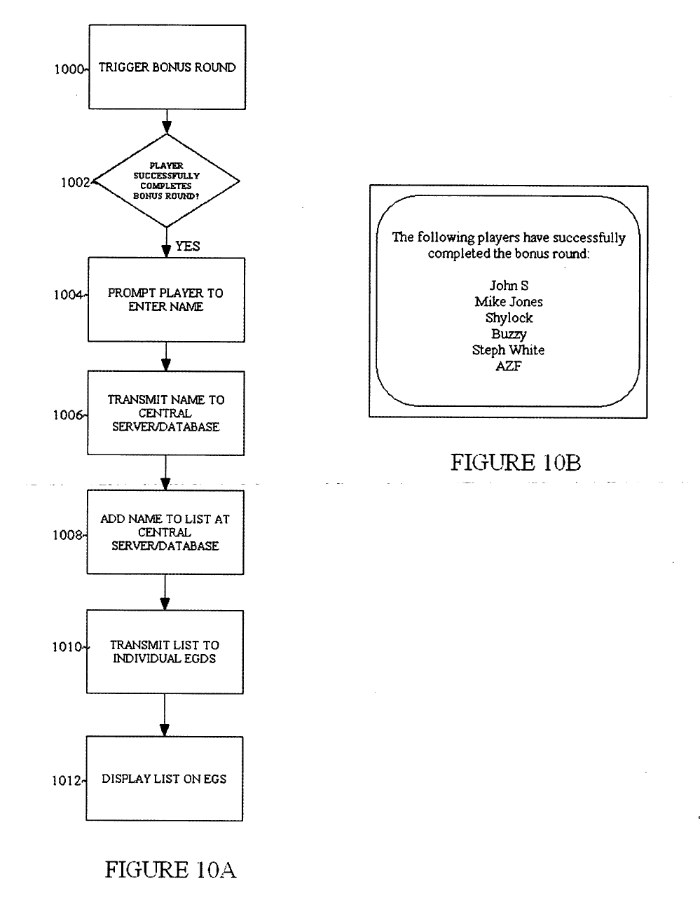

FIG. 10A is a flowchart illustrating an exemplary method of maintaining and distributing names of players who have successfully completed a bonus round, according to an embodiment.

The method can begin with operation 1000, wherein a bonus round is triggered. This can be done as described herein or as known in the art.

From operation 1000, the method can proceed to operation 1002, which determines whether the player has successfully completed the bonus round. This can be done as described herein and in the Ser. No. 11/035,691 document (which is incorporated by reference).

If the player has successfully completed the bonus round, then the method can proceed to operation 1004, wherein the player can be prompted to enter his or her name. If the player does not wish to enter his or her name, the player can skip decline to enter his or her name and proceed as normal.

From operation 1004, the method can proceed to operation 1006, wherein the EGD that the player has been using transmits the players name to the database 900.

From operation 1006, the method can proceed to operation 1008, wherein the database adds the name transmitted to it in operation 1006 by the EGD to a list of players that have successfully completed the bonus round. This list is maintained by the database 900.

From operation 1008, the method can proceed to operation 1010, wherein the database 900 transmits the list to the individual EGDs (e.g. 902, 904, 906).

From operation 1010, the method can proceed to operation 1012, wherein the EGDs, upon receiving the list from the database 900, can output the list on the EGD's output device. The list would typically be outputted when no one is currently using the EGD.

FIG. 10B is an exemplary output of names of players who have successfully completed a bonus round, according to an embodiment.

The list of players that have successfully completed the bonus round can be presented. An optional date and/or time can also be displayed alongside the player's name. If the number of players on the list exceeds a predetermined length, then optionally the entry or entries on the list that have been there the longest can be removed.

Bonus rounds can be triggered in numerous ways. For example, three or more special bonus triggering symbols may be needed on a single line to trigger a bonus round. A bonus triggering symbol is a symbol which can trigger a bonus round if the symbols satisfy a predetermined condition (e.g. a certain number of them consecutively, on a payline, or anywhere on the screen).

A further way to trigger a bonus round can be when a bonus triggering symbol appears adjacent to a scatter symbol. A scatter symbol is a symbol that pays if it appears anywhere on the screen. The more scatter symbols that appear on stopped reels, the more they pay, even though the scatter symbols do not need to be on the same payline.

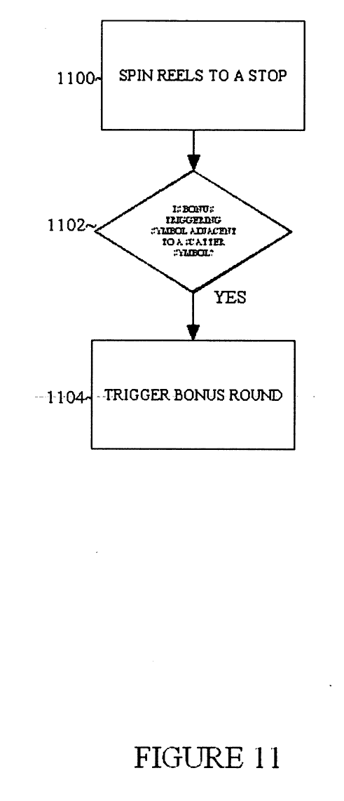

FIG. 11 is a flowchart illustrating an exemplary method of triggering a bonus round, according to an embodiment.

The method can begin with operation 1100, which spins the reels to a stop. This can be done as known in the art. The reels can be a 5×3 machine or any other dimension.

The method can proceed to operation 1102, which determines if a bonus triggering symbol is adjacent to a scatter symbol. For example, the bonus triggering symbol can be directly to the left or to the right of the scatter symbol.

If the determination in operation 1102 determines that a bonus triggering symbol is adjacent to a scatter symbol, then the method can proceed to operation 1104, which triggers a bonus round, such as any of the bonus rounds described herein. If the determination in operation 1102 determines that a bonus triggering symbol is not adjacent to a scatter symbol, then the game can proceed as normal, which would typically end and await a brand new spin.

In a further embodiment, a bonus round can be implemented in which a player tries to guess a predetermined item. For example, the game can display 10 items a mouse can be hiding in (e.g. a lamp, a TV, a rug, a chandelier, etc.) The player tries to pick where the mouse is hiding. The player typically has no way of knowing the likelihood of any item and the guess is purely random. If the player guesses right on the first try, the player wins the top prize. If the player guesses wrong, the player may be given an optional hint, such as telling the player where the mouse is not (e.g. “the mouse is not hiding in the TV.”) If the player guesses wrong, the award should typically be reduced as well. The player can then guess again by selecting one of the potential items. The method can then repeat until the player has guessed correctly. Optionally, the player may be given a finite number of guesses, upon which the player can be awarded nothing or a consolation prize.

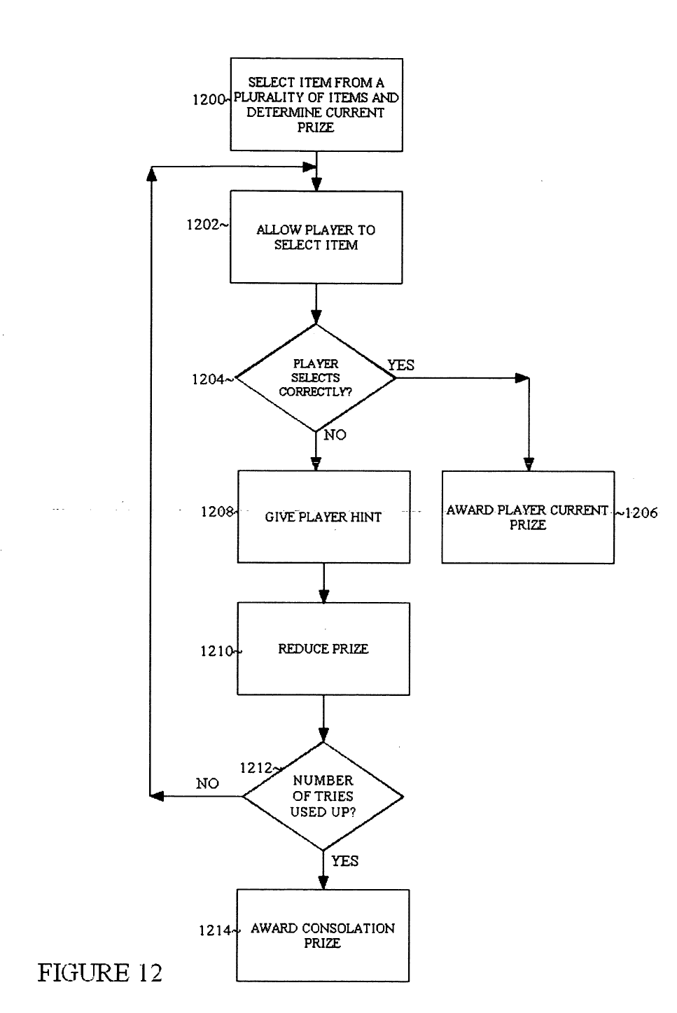

FIG. 12 is a flowchart illustrating an exemplary method of implementing a guessing bonus round, according to an embodiment.

The method can begin with operation 1200, wherein the computer selects an item from a plurality of items and determines the top prize. The selection is typically done at random. The top prize can be predetermined or selected at random from a range of values.

From operation 1200, the method can proceed to operation 1202, which allows the player to select an item. This can be done for example by allowing the player to touch an item using a touch screen.

From operation 1202, the method can proceed to operation 1204, which determines whether the player has selected correctly. If the player's selection in operation 1202 matches the computers original pick in operation 1200, then the player has selected correctly. In this case, the method can proceed to operation 1206, which awards the player the current prize. Alternatively, instead of maintaining current prizes, a current range can be maintained. For example, if the player guesses right on the first guess, his or her prize will be chosen randomly from 90-100. If the player guesses right on the second guess, his or her prize will be chosen randomly from 70-80, etc.

If the determination in operation 1204 determines the player has picked incorrectly, then the method can proceed to operation 1208, which gives the player a hint as to the selected item selected by the computer in operation 1200. For example, the hint may be saying which item is not the selected item.

From operation 1208, the method can proceed to operation 1210, which can reduce the current prize. A table can be preset with the number of guesses and a respective prize. Alternatively, a table can be preset with the number of guesses and a respective range of awards wherein the prize can be determined randomly to fall within.

From operation 1210 the method can proceed to operation 1212, which can determine if the player has used up all available guess. The player can be given a predetermined numbed of guesses. Alternatively, this operation can be optional and the player can be given as many guesses as he or she needs (although the prize will continue to be reduced). If the player has not used up all of his or her guesses, then the method can return to operation 1202 where the player can again select an item.

If the player has used up all of his or her guesses, then the method can proceed to operation 1214, which can award a consolation prize. The consolation prize can be preset to be a low number or can also be zero (no consolation prize awarded).

When the player has guessed correctly, the game can pay a prize depending on the chance number (number of guesses it took). Table III below is an exemplary table illustrating value numbers for each chance.

TABLE III

| Chance | Value |
|---|---|
| 1 | 34 |
| 2 | 23 |
| 3 | 19 |
| 4 | 16 |
| 5 | 13 |
| 6 | 10 |
| 7 | 5 |
| 8 | 3 |

These values in Table III can be awarded directly or modified by a random multiplier, selected from an uniform aleatory variable such as U(1, 1.22) (a random number in the range specified) so that the values obtained in two different games in the same chance, could be different. As an example, suppose that the player guessed correctly on the third attempt, so the obtained amount should be in the range [19, 23.18]. Any number of items and any number of guesses can be used, for example there can be twelve items to pick and eight guesses.

When the player guesses incorrectly, a consolation prize can be awarded. This prize can be predetermined from a table, randomly chosen from a range in a table, or selected from a uniform aleatory variable, such as U(1, 1.22). All these values (guessing correctly or incorrectly) are also multiplied by the total bet of the game (i.e., active pay lines*bet per line), and rounded to the closer (and lower) integer value.

In a further embodiment, a guessing bonus round can be implemented which has both positive prizes (money) and negative prizes (deducting money). An example of how this bonus round can operate is as follows. The player can be presented with a plurality (e.g. 15 or any number) of concealed elements. A concealed element is an element that can be chosen which has a value behind it that can be hidden from the user. When the player chooses a concealed element, its content is then revealed. The game also outputs to the player that there are 10 positive prizes and 5 negative prizes. The player then chooses a first concealed element, which reveals a positive prize. The player's bonus award is increased (it can start at zero or another number) which is outputted and the first concealed element is no longer available for selection. The game now indicates that there are 9 positive prizes and 5 negative prizes left. The player can choose to continue picking or keep his current bonus award and quit. The player chooses to pick again and picks a second concealed element which reveals a negative prize. The players bonus award is now reduced (the amount reduced can be fixed or determined at random). The game now indicates that there are 9 positive prizes and 4 negative prizes left. The player can continue to pick in this manner until all concealed elements have been revealed or if the player decides to keep his current award even though there more be more unconcealed elements to pick. The player may wish to end the bonus game early if he or she feels there are too many negative prizes left and would prefer to take the current award.

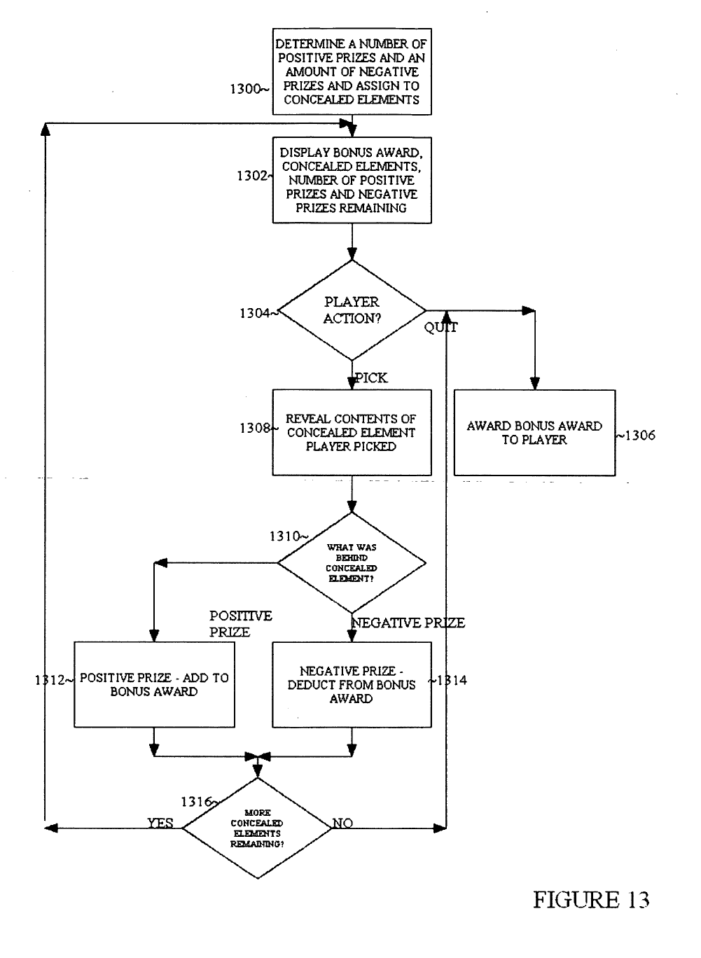

FIG. 13 is flowchart illustrating an exemplary method of implementing a positive/negative guessing bonus round, according to an embodiment.

The method can begin with operation 1300, which determines a number of positive prizes and negative prizes, and assigns each concealed element to one of these types. The value each positive prize and negative prize (a negative value) can also be determined now (either fixed or from a random range), or these values can be determined at a later time (e.g. when the prize is revealed). An initial bonus award can also be assigned to the player (can be zero or another number).

From operation 1300, the method can proceed to operation 1302, which displays the player's bonus award, the concealed elements (and also the elements already picked and uncovered), the number of positive prizes, and the number of negative prizes remaining.

From operation 1302, the method can proceed to operation 1304, wherein the player can either pick a concealed element or terminate the bonus round and collect the bonus award.

If from operation 1304, the player decides to terminate the bonus round, the method can proceed to operation 1306, wherein the player can then collect the bonus award and the bonus round ends. The player may wish to do this if there are excessive negative prizes left. Thus, this bonus round has an element of strategy to it.

From operation 1304, if the player decides to pick a concealed element, then the method can proceed to operation 1308, which reveals the contents of the picked concealed element.

From operation 1308, the method can proceed to operation 1310, which determines the contents of the picked concealed element. If the picked concealed element was a positive prize, then the method can proceed to operation 1312, which awards the positive prize to the bonus amount. The positive prize can be predetermined or determined when it is picked.

From operation 1310, if it is determines that the contents of the picked concealed element was a negative prize, then the method can proceed to operation 1314, which awards the negative prize to the bonus amount. The negative prize is typically a negative number which decreases the value of the bonus amount. The negative prize can be predetermined or determines when it is picked.

From operations 1312 or 1314, the method can proceed to operation 1316, which determines if there are more concealed elements remaining. If there are more unconcealed elements that haven't been picked yet by the player, then the method can proceed to operation 1302, wherein the bonus round continues.

If operation 1316 determines that there are no more concealed elements to pick, then the method can proceed to operation 1306, which awards the bonus amount to the player and ends the bonus round.

Table IV illustrates one example of how to compute payouts when the player gets a positive prize. Thus when the player gets a positive prize, the game selects a value from the following table, according to its probability. The value is added to the total win. For example, there is a 15% chance of receiving a value of 2 for a positive prize, and a 2% chance of receiving a value of 20 for a positive prize.

TABLE IV

| Value | prob |
|---|---|
| 2 | 15% |
| 3 | 15% |
| 4 | 15% |
| 5 | 20% |
| 7 | 15% |
| 10 | 8% |
| 12 | 6% |
| 15 | 4% |
| 20 | 2% |

When the player gets a negative prize, a percentage of the last obtained positive prize can be taken. The percentage can be selected from a uniform aleatory variable U(20%, 40%) (a random number ranging from 20 to 40, although of course other ranges can be used as well). If there were no last positive prize, the game may simply not subtract any value. There can be any number of concealed elements, such as eight. There also can be any combination of positive prizes and negative prizes dispersed randomly. For example, there can be from two to six positive prizes (chosen randomly) and the rest negative prizes.

All these values (positive and negative prizes) can also be multiplied by the total bet of the game (i.e., active pay lines*bet per line), and rounded to the closer (and lower) integer value.

It is noted that any of the operations described herein can be performed in any sensible order. Further, any operations may be optional. Also, any feature or embodiment described herein can be combined with any other.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a wagering game, the method comprising:
displaying an active area;
receiving continuous touching from a player inside the active area; and
awarding an award to the player after the continuous touching is completed.

2. A method as recited in claim 1, wherein the award is predetermined.

3. A method as recited in claim 1, wherein the award is determined based on characteristics of the continuous touching.

4. A method as recited in claim 3, further comprising displaying an animal in the active area.

5. A method as recited in claim 4, further comprising:
initially displaying the animal in a first state; and
displaying the animal in a second state based on the continuous touching.

6. A method as recited in claim 5, wherein the second state is indicative of the animal's contentment.

7. A method as recited in claim 5, wherein the second state is displayed when the player has performed the continuous touching to meet a predetermined condition.

8. A method as recited in claim 7, wherein the predetermined condition is an accrual of a predetermined amount of points during the continuous touching.

9. A method as recited in claim 1, further comprising:
dividing the active area into cells;
when the player touches a particular cell, adding a value of the particular cell to a point total and resetting the value of the particular cell;
increasing values of the cells;
continuing the adding, resetting and increasing until a time limit is over; and
when the time limit is over, determining the award based on the point total.

10. A method as recited in claim 9, wherein the increasing increases the values of the cells whenever a new cell is touched by the player.

11. A method to play a wagering game, the method comprising:
dividing an active area into cells and initializing values of the cells;
allowing a player to touch any of the cells;
when the player touches a particular cell, adding a value of the particular cell to a point total and resetting the value of the particular cell;
increasing values of the cells;
continuing the allowing, adding, resetting and increasing, until a time limit is over; and
when the time limit is over, determining an award based on the point total.

12. A method as recited in claim 11, wherein the award is determined by:
categorizing point totals into a plurality of states, each state with a respective low range and a high range;
determining a current state out of the plurality of states that the point total falls into; and
selecting a random number between the current state's respective low range and a respective high range.

13. A method as recited in claim 12, further comprising multiplying the random number by an amount bet.

14. A method as recited in claim 11, further comprising:
outputting, when the point total reaches a predetermined amount, an indication that the player has achieved a measure of success.

15. A method as recited in claim 11, wherein the increasing increases the values of the cells whenever a new cell is touched by the player.

16. A method of displaying successful players on a slot game, the method comprising:
triggering a bonus round on a slot machine;
allowing players to guess a preselected item for the bonus round;
if the player guesses incorrectly then continuing the triggering and allowing without changing the preselected item;
if the player guesses correctly, then performing:
inputting the player's name on the slot machine;
transmitting the player's name to a central server;
adding, by the central server, the player's name to a list of successful players;
transmitting the list to a plurality of slot machines; and
displaying the list on the plurality of slot machines.
